(19) United States
(12) Patent Application Publication
(10) Pub. No.: US 2012/0206266 A1
(43) Pub. Date: Aug. 16, 2012

(54) Heat Detection System

(76) Inventor: William Moons, Elizabeth, CO (US)

(21) Appl. No.: 13/027,848

(22) Filed: Feb. 15, 2011

(51) Int. Cl. G08B 17/00

(52) U.S. Cl. 340/584

(57) ABSTRACT

A heat detection system includes a temperature sensor configured for mounting in a grill interior area for determining a temperature. A transmitter is positioned outside the interior area and electrically connected to the temperature sensor to transmit a signal indicative of the temperature. A receiver is remote from the transmitter and configured to receive the temperature signal. A processor is connected to the receiver for evaluating the temperature signal. A timer and alarm are connected to the processor. The system includes programming that causes the processor to determine if the evaluated temperature exceeds a predetermined temperature, to actuate the timer if the evaluated temperature exceeds the predetermined temperature, and to actuate the alarm if the timer has expired. The system also includes programming to determine if the evaluated temperature has increased over a previously evaluated temperature more than a predetermined amount in less than a predetermined amount of time.

### BACKGROUND OF THE INVENTION

This invention relates generally to heat detection devices and, more particularly, to a heat detection system specifically configured for use in determining a temperature within the interior area of an outdoor grill and which evaluates that temperature in relation to time. Specifically, the heat detection system evaluates if an interior grill temperature has exceeded a predetermined temperature for an undesirable duration of time and also evaluates if a temperature within the interior of a grill housing has increased so rapidly as may be indicative of a fire event.

Outdoor grilling is a popular means of food preparation as well as a popular social occasion. People frequently fire up their grills in times of good weather and prepare various types of meat for family and friends. In fact, some people are such grilling enthusiasts that they enter barbeque contests or use their grills to experiment with new grilling techniques that they learn from cooking shows on television or the Internet.

Grills that operate using a gas-fed flame, such as a propane gas grill, pose a danger in that it is not always obvious if the grill has been completely deactivated following a grilling event. In such a situation, a user may close the grill lid, put a cover over the grill, and otherwise store the grill away and, as a result, create the risk of starting a fire. A fire started by an unattended grill may not be discovered until a garage or home is completely engulfed in flames—especially if the residents have left home believing the grill to be turned off.

Therefore, it would be desirable to have a heat detection system specifically configured for use with a grill of the type having a pivotal lid and interior area in which a temperature may be continuously monitored. Further, it would be desirable to have a heat detection system in which a detected temperature may be transmitted to a receiver located remotely from the grill itself or even to a cellular telephone or wireless internet network. In addition, it would be desirable to have a heat detection system configured to determine if a temperature higher than a predetermined or user supplied temperature has been maintained for longer than a predetermined amount of time. In other words, if the grill is determined to have maintained a high temperature for much longer than the assumed duration of a grilling event, then it would be desirable to activate an alarm. It would also be desirable to determine if the temperature of a grill is rising faster than would normally be expected of a deactivated grill—even in bright sunshine—or by an activated grill that is warming to a reasonable cooking temperature.

### SUMMARY OF THE INVENTION

A heat detection system for use with an outdoor grill includes a temperature sensor configured for mounting in a grill interior area for determining a temperature. A transmitter is positioned outside the interior area and electrically connected to the temperature sensor to transmit a signal indicative of the temperature. A receiver is remote from the transmitter and configured to receive the transmitted temperature signal. A processor is connected to the receiver for evaluating the temperature signal. A timer and alarm are connected to the processor. The system includes programming that causes the processor to determine if the evaluated temperature exceeds a predetermined temperature, to actuate the timer if the evaluated temperature exceeds the predetermined temperature, and to actuate the alarm if the timer has expired. The system also includes programming to determine if the evaluated temperature has increased over a previously evaluated temperature more than a predetermined amount in less than a predetermined amount of time.

Therefore, a general object of this invention is to provide a heat detection system specifically configured to evaluate the temperature on the interior of an outdoor grill so that a user is alerted if the grill has been left on beyond a predetermined amount of time or if the interior grill temperature has increased too rapidly.

Another object of this invention is to provide a heat detection system, as aforesaid, that enables a user to wirelessly and remotely monitor the temperature of an interior area of an outdoor grill.

Still another object of this invention is to provide a heat detection system, as aforesaid, in which a user may enter a threshold temperature above which an alarm will be activated if that temperature is maintained or exceeded for too long a duration.

Yet another object of this invention is to provide a heat detection system, as aforesaid, having a temperature sensor that is housed in a high temperature resistant casing so as to be durable when positioned in the interior area of a grill.

A further object of this invention is to provide a heat detection system, as aforesaid, that is easy to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a heat detection system in use with an outdoor grill according to a preferred embodiment of the present invention, the grill being shown with its lid in an open configuration;

FIG. 2 is a perspective view of a heat detection system as in FIG. 1 with the grill lid shown in a closed configuration;

FIG. 3 is a front view of a heat detection system as in FIG. 1;

FIG. 4 is an exploded view of a heat detection system as in FIG. 2;

FIG. 5a is an isolated view on an enlarged scale of the receiving unit as in FIG. 4;

FIG. 5b is an isolated view on an enlarged scale of the transmitter unit as in FIG. 4;

FIG. 6 is an isolated perspective view of the temperature sensor as in FIG. 4;

FIG. 7 is a block diagram illustrating the electronic components of the heat detection system according to the present invention; and

FIG. 8 is a flowchart illustrating an exemplary embodiment of the logic performed by a processor according to the present invention.

### DESCRIPTION OF THE PREFERRED EMBODIMENT

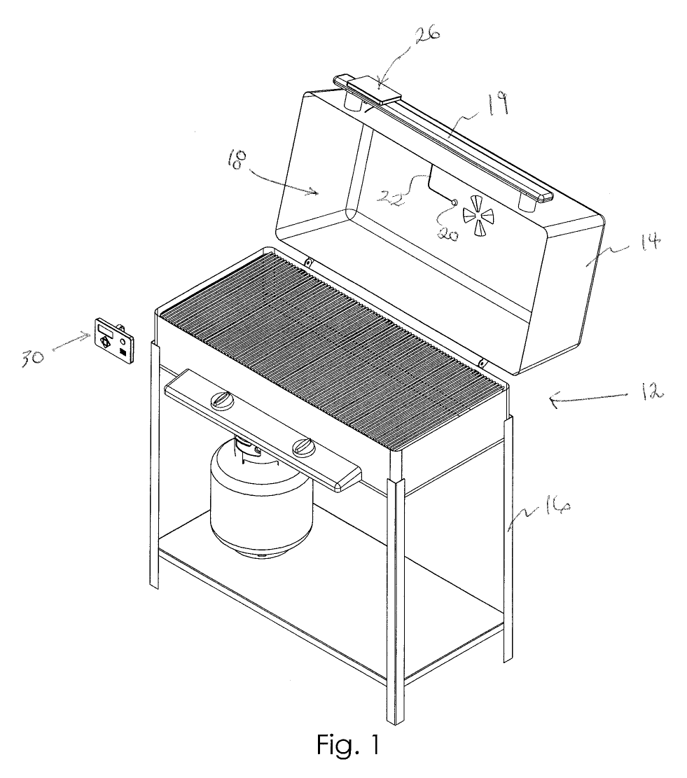

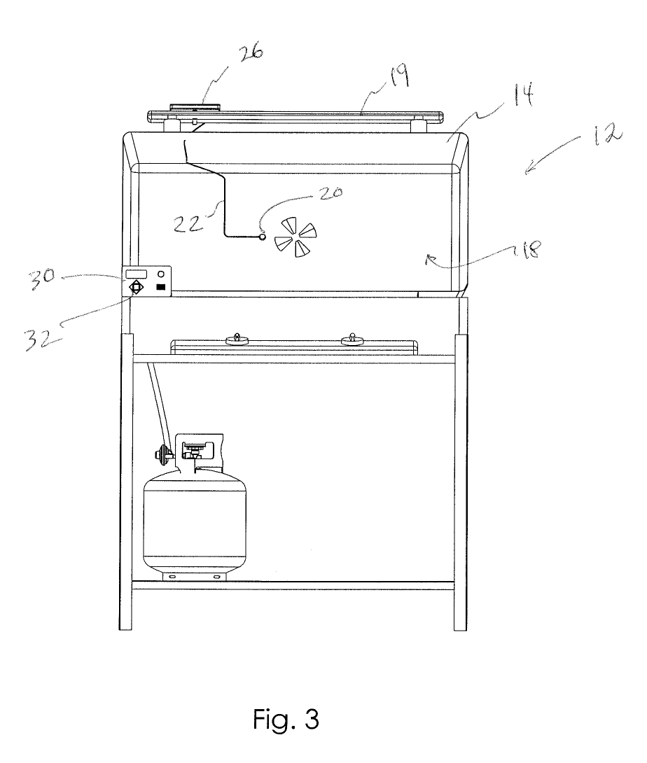

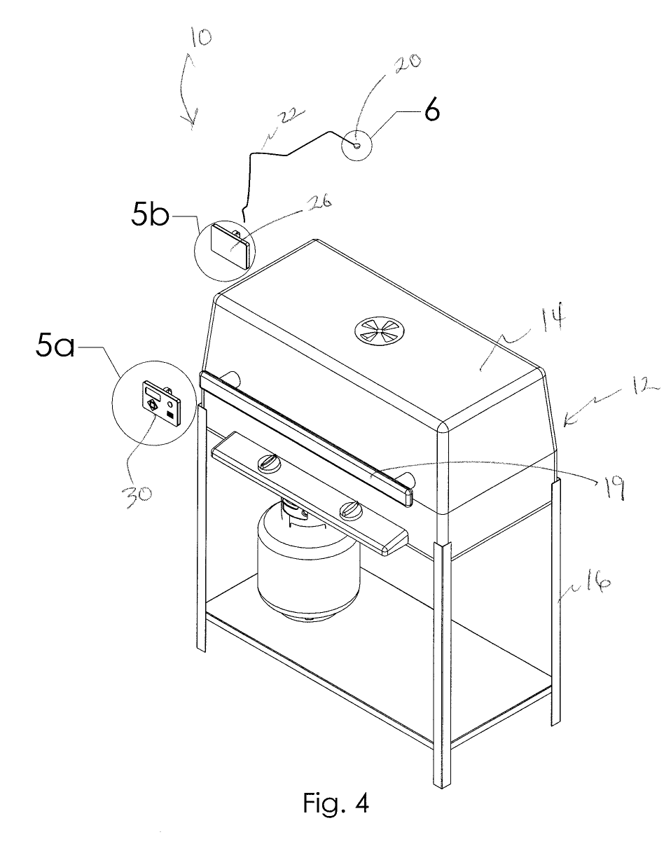

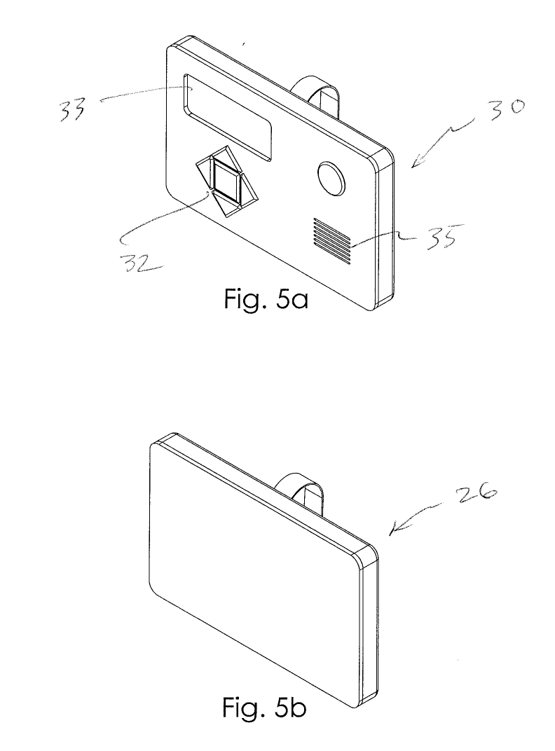

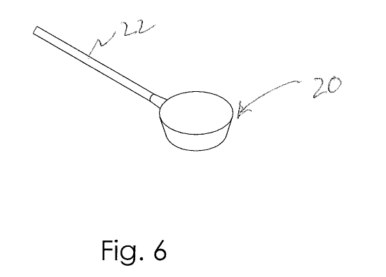

A heat detection system according to a preferred embodiment of the present invention will now be described with reference to FIGS. 1 to 8 of the accompanying drawings. The heat detection system 10 includes a temperature sensor 20, a transmitter 24, a receiver 28, and a processor 38 associated with programming for evaluating specific temperature conditions with an interior area 18 of a grill 12.

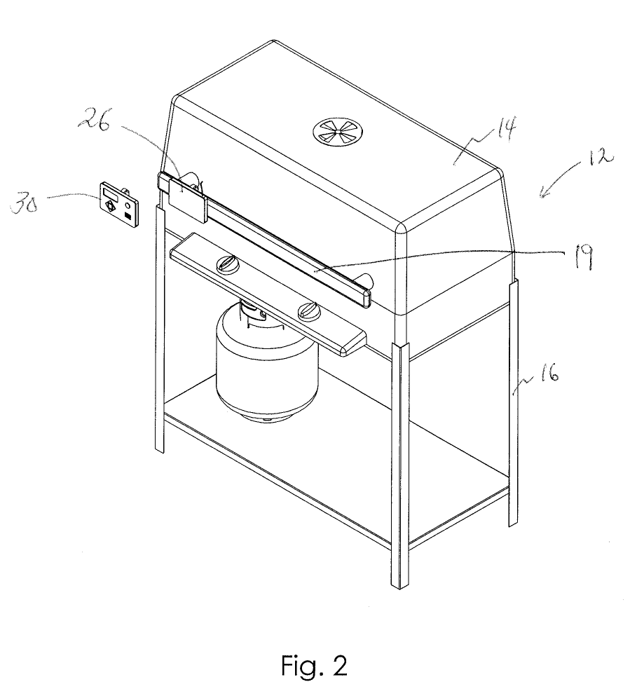

The heat detection system 10 is intended and configured for use with a grill 12 of the type having a grill housing situated atop a supportive framework 16 such as that shown in FIGS. 1 and 2. The grill housing includes a lid 14 that may be pivotally moved between open (FIG. 1) and closed (FIG. 2) configurations. The grill housing defines an interior area. The present invention relates specifically to obtaining and evaluating a temperature within the interior area of the grill housing especially when the lid 14 is at the closed configuration, such as times when the grill is not in use. It is understood that the term “grill” and “grill housing” may be used equivalently in the following description and claims.

The temperature sensor 20 (which may also be described as a “temperature probe”) may be situated in the interior area 18 of a grill housing. Preferably, the temperature sensor 20 is mounted to an inner surface of the lid 14. It is understood that the temperature sensor 20 may be permanently attached to the inner surface of the lid 14 at the point of manufacture or as an aftermarket product. Further, the temperature sensor 20 may be encased in a material that is durable at very high temperatures as may be experienced inside of the grill housing. For instance, the temperature sensor 20 may be positioned inside a sensor housing constructed of silicone or other high temperature durable plastic. A data cable 22 connects the temperature sensor 20 to the transmitter 24. The sensor 20, sensor housing, and data cable 22 may be attached to the inner surface of the lid 14 with screws, rivets, cable routing clamps, or the like.

The transmitter 24 may be situated in a transmitter housing 26 configured to attach to an outer portion of the grill housing, such as to a handle 19 or the like (FIG. 2). The transmitter 24 itself is situated inside the transmitter housing 26 and is electrically connected to the data cable 22 for data communication with the temperature sensor 20. The transmitter 24 is configured to transmit a signal indicative of a temperature detected/determined by the temperature sensor 20. When the temperature sensor 20 is positioned in the grill lid 14 and the lid 14 is at the closed configuration, the transmitter 24 transmits a wireless signal accurately representative of a temperature inside the interior area 18 of the grill 12.

The receiver 28 is preferably situated inside a receiver housing 30 and configured to receive the temperature signal from the transmitter. The receiver housing 30 is intended to be located or positioned remote from the grill 12 and transmitter 24 such that a grill temperature may be monitored from a remote location, such as inside a house. The processor 38 is also situated inside the receiver housing 30 and is electrically connected to the receiver 28. When the temperature signal is received by the receiver 28 it is conveyed to the processor, the processor 38, the processor being configured to evaluate the temperature signal. In other words, the processor 38 is able to convert the signal into a temperature reading.

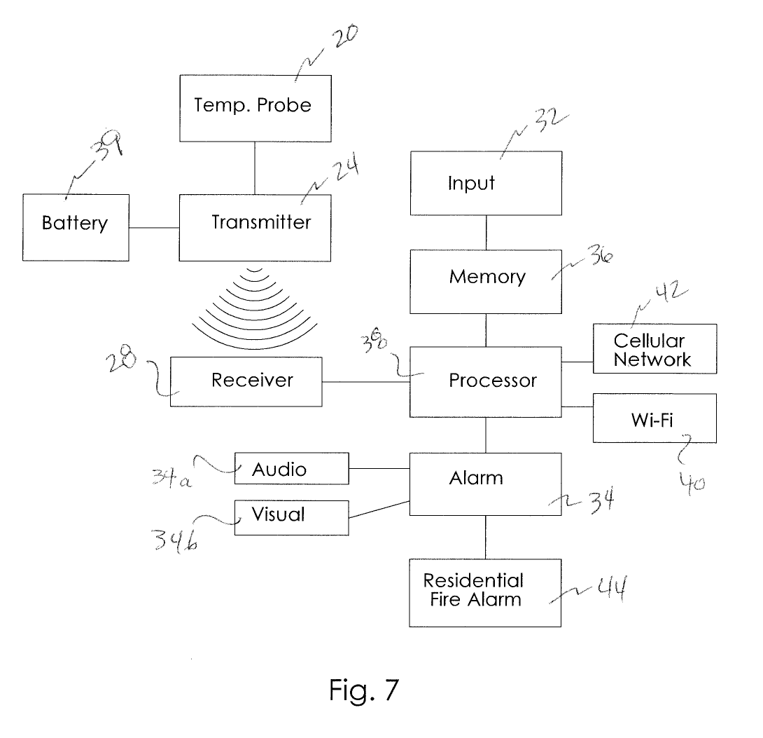

The heat detection system 10 includes an input device 32 (also referred to simply as an “input”). The input 32 may be one or more buttons, a keypad, or the like. The input 32 may be used by a user of the system to enter values into memory for use by the program instructions as described below. Values that may be entered using the input 32 include (1) a predetermined temperature that, if sustained for more than a predetermined amount of time, will cause an alarm 34 to activate, a rate of temperature rise that would be considered “excessive,” or other parameters. The alarm 34 is preferably positioned in the receiver housing 30 and includes both audio 34a and visual 34b alert elements. The receiving unit 30 may also include a display 33, speaker 35, or the like. It is understood that the temperature sensor 29, transmitter 24, receiver 28, and other electronic components may each be powered by a battery 39 (as specifically shown with regard to the transmitter 24 in FIG. 7).

The heat detection system includes a plurality of program instructions (i.e. programming) that, when executed, by the processor 38, monitor various temperature conditions within the grill housing and alert a user of dangerous conditions. The programming may be stored in memory 36 for execution by the processor 38. The heat detection system 10 also includes a timer 33 and an alarm 34 electrically connected to the processor for operative communication therewith as described below.

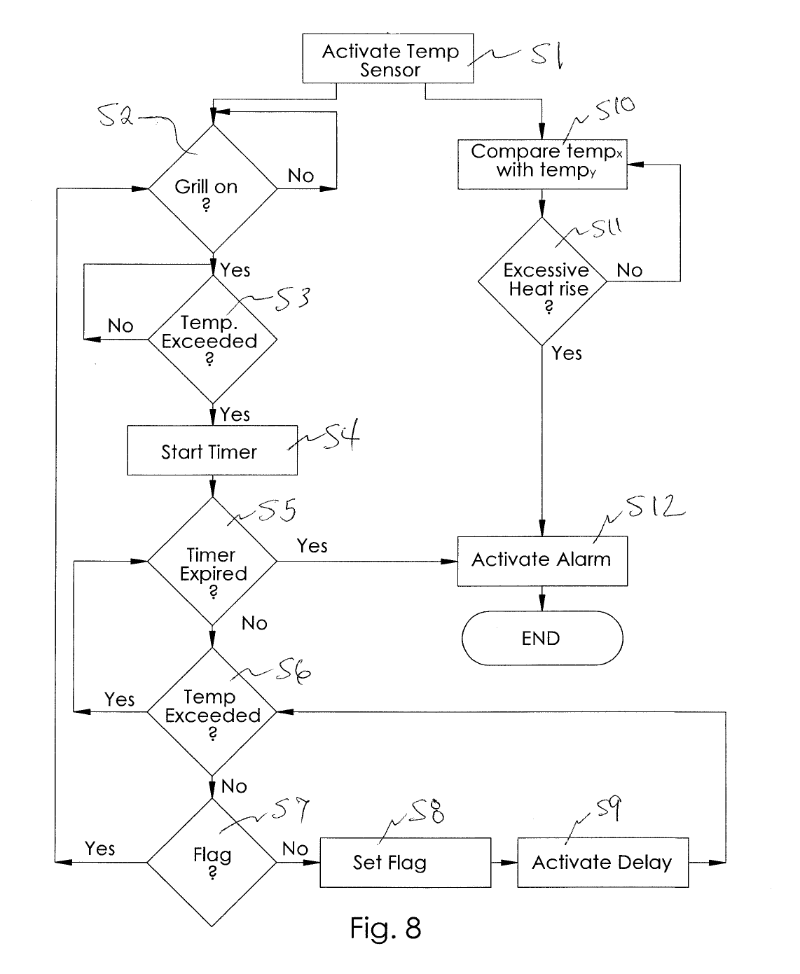

FIG. 8 is an exemplary flowchart illustrating execution of the processor 38 carrying out the program instructions of the present invention. It is understood that readings of the grill temperature are continuously (or at predetermined intervals) by the temperature sensor 20 and being communicated to the processor 38 as described above. At S1, the temperature sensor 20 is activated. It is understood that the temperature sensor 20 may be energized by a battery or A/C power supply (not shown). When activated, the temperature continuously reads a temperature of surrounding ambient air, although it may be configured to obtain a temperature reading at predetermined intervals of time. At step S2, the processor 38 determines if the grill (i.e. the grill burner) is activated and, if so, proceeds to step S3. Otherwise, the processor returns to step S2 in which the processor 38 continues to test for grill activation. At step S3, the processor 38 determines if a predetermined grill temperature has been exceeded and, if so, proceeds to step S4. Otherwise, the processor 38 returns to step S3. In other words, if the grill temperature remains below the threshold temperature, the processor 38 remains in a loop waiting for the temperature to exceed the threshold temperature.

If the grill temperature was found to exceed a predetermined temperature as discussed above at step S3, then the processor 38 causes the timer 33 to be activated at step S4. For example, the timer 33 counts down for a specific amount of time, expiration of which is indicative that the grill 12 has experienced a threshold amount of heat for an unacceptable amount of time, such as where a grill has mistakenly been left on or may be experiencing a fire. At step S5, the processor 38 determines if the timer 33 has expired and, if so, proceeds to step S12 and actuates the alarm 34. Otherwise, the processor 38 proceeds to step S6. At step S6, the processor 38 determines if the grill temperature still exceeds the predetermined temperature and, if so, proceeds to step S5 and monitoring of the timer 33 is continued. Otherwise, the processor 38 proceeds to step S7. This test checks to see if the temperature has now dipped below the threshold temperature as that may indicate that the previous temperature and timer routines were a false alarm.

At step S7, the processor 38 determines if a flag has previously been set which is indicative that the temperature has dipped below the threshold temperature and, if so, control returns to step S2 and the entire procedure of monitoring whether the grill temperature is above a predetermined temperature for a predetermined period of time is started again. Otherwise, a flag is set at step S8 and the processor 38 waits a predetermined amount of time at step S9. It is understood that this intentional pause/delay is to test whether the lowered temperature is sustained for long enough to justify canceling the timer or was just a momentary or erroneous reading. The length of this intentional delay may be a default value or input by a user. Then, the processor 38 returns control to step S6 to once again determine if the temperature remains below the threshold temperature or if it has again returned to an elevated condition.

After step S1, the processor 38 proceeds to step S10 simultaneously with proceeding to step S2 as described previously. In other words, the processor 38 is configured to spawn multiple processes to run at the same time. It is well known that modern processors are able to multi-process several processes at the same time by “sharing” processor time very quickly. It is understood that the process initiated at step S10 proceeds whether the grill is activated or deactivated. In the process illustrated at step S10, the processor 38 compares a current grill temperature with a previously read and stored grill temperature. In FIG. 8, this comparison is illustrated as subtracting a previous grill temp, from a current grill temp_{y}. In other words, the amount of temperature rise is calculated. Then, at step S11, the processor 38 determines if the rate of heat rise is an acceptable amount. To do this, the processor 38 will evaluate the numeric temperature increase in view of a predetermined amount of time. The amount of time between compared temperature readings may be a default amount of time or be set by the user using the input 32. If this ratio is determined to be “excessive,” then the processor 38 proceeds to step S12 and the alarm 34 is activated. Otherwise, step S10 is repeated at predetermined intervals of time. The threshold acceptable rate of temperature increase may be a default value stored in memory 36 or a value entered by a user.

It is understood that the predetermined temperature, the timer duration, the threshold level of acceptable heat rise increase utilized by the programming may be default values or may be entered by a user using the input 32 and stored in memory.

The processor 38 is configured to connect to a wireless internet network 40 (“Wi-Fi”) such that the processor 38 may be selectively controlled and monitored remotely from a computer through the network. Similarly, the processor 38 may be connected to a cellular telephone network 42 so that it may be monitored and controlled from a cellular telephone. Further, the processor 38 may be connected to a residential or commercial security system 44 so that the security system alarm or emergency personnel notifications are activated when the grill heat detection system 10 indicates an alert condition.

It is understood that while certain forms of this invention have been illustrated and described, it is not limited thereto except insofar as such limitations are included in the following claims and allowable functional equivalents thereof.

1. A heat detection system for use with an outdoor grill defining an interior area, said heat detection system comprising:
a temperature sensor configured to be mounted in the interior area of the grill for determining a temperature within the interior area;
a transmitter positioned outside of the interior area of the grill that is electrically connected to said temperature sensor, said transmitter configured to transmit a temperature signal indicative of said temperature determined by said temperature sensor;
a receiver remote from said transmitter configured to receive said temperature signal from said transmitter;
a processor electrically connected to said receiver and configured to evaluate said temperature signal received by said receiver;
a timer electrically connected to said processor;
an alarm electrically connected to said processor;
programming causing said processor to:
(a) determine if said evaluated temperature exceeds a predetermined temperature;
(b) actuate said timer if said evaluated temperature exceeds said predetermined temperature;
(c) determine if said timer has expired;
(d) actuate said alarm if said timer has expired;
programming causing said processor to:
(e) determine if said evaluated temperature has increased over a previously evaluated temperature more than a predetermined amount in less than a predetermined amount of time; and
(f) actuate said alarm if said evaluated temperature has increased over a previously evaluated temperature more than a predetermined amount in less than a predetermined amount of time.

2. The heat detection system of claim 1, wherein said programming to cause said processor to determine if said evaluated temperature has increased over a previously evaluated temperature more than a predetermined amount in less than a predetermined amount of time includes programming to compare a current evaluated temperature with a previously evaluated temperature received a predetermined amount of time prior to receipt of said current evaluated temperature.

3. The heat detection system of claim 2, wherein said timer operates for one of a default time and a time input by a user.

4. The heat detection system of claim 3, wherein said predetermined amount of temperature increase is one of a default amount and an amount input by a user.

5. The heat detection system of claim 2, wherein said programming to determine if said timer has expired includes programming to determine if said evaluated temperature no longer exceeds said predetermined temperature before said timer has expired.

6. The heat detection system of claim 5, wherein said programming to determine if said evaluated temperature no longer exceeds said predetermined temperature before said timer has expired includes programming to determine if said evaluated temperature no longer exceeds said predetermined temperature for a predetermined duration of time.

7. The heat detection system of claim 1, further comprising:
a memory device electrically connected to said processor; and
an input operatively connected to said processor configured to enable a user to enter said predetermined temperature, said user entered predetermined temperature being stored in said memory.

8. The heat detection system of claim 7, wherein said predetermined amount of temperature increase and said predetermined amount of time are set with said input and stored in said memory.

9. The heat detection system of claim 1, wherein said processor is configured to operatively connect to a wireless internet network so that said processor is selectively monitored and controlled remotely using said wireless internet network.

10. The heat detection system of claim 9, wherein said processor is configured to operatively connect to a cellular telephone network so that said processor is selectively monitored and controlled using said cellular network.

11. The heat detection system of claim 1, wherein said alarm is operatively connected to a residential electronic security system so that said security system is activated when said alarm is activated.

12. The heat detection system as in claim 1, wherein said alarm includes an audio alarm and a visual alarm.

13. The heat detection system as in claim 1, further comprising:
a transmitter housing configured to receive said transmitter therein;
a battery positioned in said transmitter housing and electrically connected to said transmitter; and
means for mounting said transmitter housing outside said grill interior space.

14. The heat detection system of claim 13, further comprising a receiver housing configured to house said input, said processor, said receiver, and said alarm.

15. A method for detecting heat conditions in an outdoor grill that defines an interior area, said method comprising the steps of:
providing:
a temperature sensor configured to be mounted in the interior area of the grill;
a transmitter configured to be attached outside of the interior area of the grill;
a receiver positioned remotely from said transmitter;
a processor electrically connected to said receiver;
a timer operatively connected to said processor;
an alarm electrically connected to said processor;
activating said temperature sensor to determine a current grill temperature within the internal area of the grill;
energizing said transmitter to transmit a temperature signal indicative of said current grill temperature;
energizing said receiver to receive said current grill temperature signal;
determining if said current grill temperature exceeds a predetermined temperature;
actuating a timer if said grill temperature exceeds a predetermined temperature;
determining if said timer has expired;
energizing said alarm if said timer has expired;
comparing said current grill temperature to a previous grill temperature so as to determine a rate of temperature increase over a predetermined amount of time; and
energizing said alarm if said rate of temperature increase is greater than a threshold rate of temperature increase.

16. The method for detecting heat conditions in an outdoor grill of claim 15, wherein said step of determining if said timer has expired includes the steps of:
determining if said current grill temperature still exceeds said predetermined temperature; and
canceling said timer if said current grill temperature no longer exceeds said predetermined temperature while said timer has not expired.

17. The method for detecting heat conditions in an outdoor grill of claim 16, wherein said step of determining if said current grill temperature still exceeds said predetermined temperature includes the step of determining if said current grill temperature still exceeds said predetermined temperature for a predetermined duration of time.

18. The method for detecting heat conditions in an outdoor grill of claim 17, further comprising:
providing a memory device electrically connected to said processor;
providing an input operatively connected to said processor with which said predetermined temperature and said threshold rate of temperature increase is entered by a user; and
storing said predetermined temperature and said rate of temperature increase in said memory device.

19. The method for detecting heat conditions in an outdoor grill of claim 15, wherein:
said processor is configured to operatively connect to a wireless internet network so that said processor is selectively monitored and controlled remotely using said wireless internet network; and
said processor is operatively connected to a cellular telephone network so that said processor is selectively monitored or controlled using said cellular network.

20. The method for detecting heat conditions in an outdoor grill of claim 15, wherein said processor is operatively connected to a residential electronic security system so that said security system is activated if said alarm is activated.
